(19) United States
(12) Patent Application Publication
(10) Pub. No.: US 2013/0122338 A1
(43) Pub. Date: May 16, 2013

(54) ELECTRIC VEHICLE BATTERY PACK

(71) Applicant: HONDA MOTOR CO., LTD., Tokyo (JP)

(72) Inventors: Goichi KATAYAMA, Wako (JP); Koichi YAMAMOTO, Wako (JP); Kosuke ITO, Wako (JP)

(73) Assignee: HONDA MOTOR CO., LTD., Tokyo (JP)

(21) Appl. No.: 13/656,743

(22) Filed: Oct. 22, 2012

(30) Foreign Application Priority Data
Nov. 14, 2011 (JP) 2011-248435

(51) Int. Cl. H01M 2/12

(52) U.S. Cl. 429/83

(57) ABSTRACT

An electric vehicle battery pack includes a battery case, a cooling air intake member, a cooling air exhaust member, and a first cooling fan. The cooling air is to be drawn through the cooling air intake member into a cooling passage. The cooling air intake member is disposed between the battery case and a passenger compartment. The cooling air is to be exhausted through the first cooling air exhaust member from the cooling passage. The first cooling air exhaust member includes a first cooling air exhaust passage through which the cooling air from the cooling passage is to flow. The first cooling air exhaust member is disposed between the battery case and the passenger compartment. At least a part of the first cooling air exhaust passage is disposed between the first cooling fan and the passenger compartment.

### CROSS-REFERENCE TO RELATED APPLICATIONS

The present application claims priority under 35 U.S.C. §119 to Japanese Patent Application No. 2011-248435, filed Nov. 14, 2011, entitled “Electric Vehicle Battery Pack.” The contents of this application are incorporated herein by reference in their entirety.

### BACKGROUND OF THE INVENTION

1. Field of the Invention

The present disclosure relates to an electric vehicle battery pack.

2. Discussion of the Background

Japanese Unexamined Patent Application Publication No. 2008-141945 describes an electric vehicle battery pack including an air intake duct, a buttery case, a first exhaust air duct, a ventilation fan, and a second exhaust air duct connected in series. By driving the ventilation fan and supplying the air in the passenger compartment drawn through the air intake duct to the battery case, the battery is cooled. The air exhausted from the battery case is exhausted via the first exhaust air duct, the ventilation fan, and the second exhaust air duct.

### SUMMARY OF THE INVENTION

According to one aspect of the present invention, an electric vehicle battery pack includes a battery case, a cooling air intake member, a cooling air exhaust member, and a first cooling fan. The battery case is disposed under the passenger compartment of an electric vehicle to contain a plurality of batteries. The battery case includes a cooling passage through which cooling air is to pass. The cooling air is to be drawn through the cooling air intake member into the cooling passage. The cooling air intake member is disposed between the battery case and the passenger compartment. The cooling air is to be exhausted through the first cooling air exhaust member from the cooling passage. The first cooling air exhaust member includes a first cooling air exhaust passage through which the cooling air from the cooling passage is to flow. The first cooling air exhaust member is disposed between the battery case and the passenger compartment. The first cooling fan is to exhaust the cooling air from the first cooling air exhaust passage to outside of the first cooling air exhaust member. At least a part of the first cooling air exhaust passage is disposed between the first cooling fan and the passenger compartment. The support frame is provided on the battery case to support the first cooling air exhaust member and the first cooling fan.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIGS. 1A and 1B are side views of an electric vehicle.

FIG. 2 is a perspective view of an undercarriage of a vehicle and a battery pack.

FIG. 3 is a perspective view of the battery pack.

FIG. 4 is a view on arrow “IV” of FIG. 1A.

FIG. 5 is a cross-sectional view taken along a line V-V of FIG. 4.

FIG. 6 is a cross-sectional view taken along a line VI-VI of FIG. 4.

FIG. 7 is an enlarged view of a main portion illustrated in FIG. 4.

FIG. 8 is a cross-sectional view taken along a line VIII-VIII of FIG. 7.

FIG. 9 is a view on arrow IX of FIG. 7.

FIG. 10 is a view on arrow X of FIG. 9.

FIG. 11 illustrates the operation of the battery pack illustrated in FIG. 3.

### DESCRIPTION OF THE EMBODIMENTS

The embodiments will now be described with reference to the accompanying drawings, wherein like reference numerals designate corresponding or identical elements throughout the various drawings.

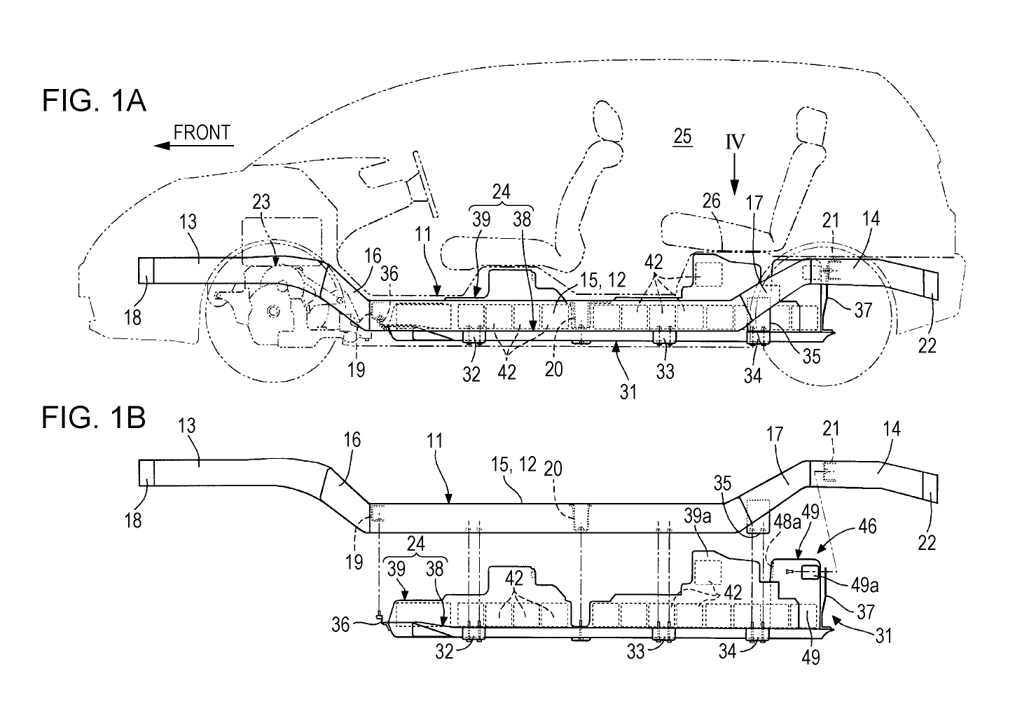

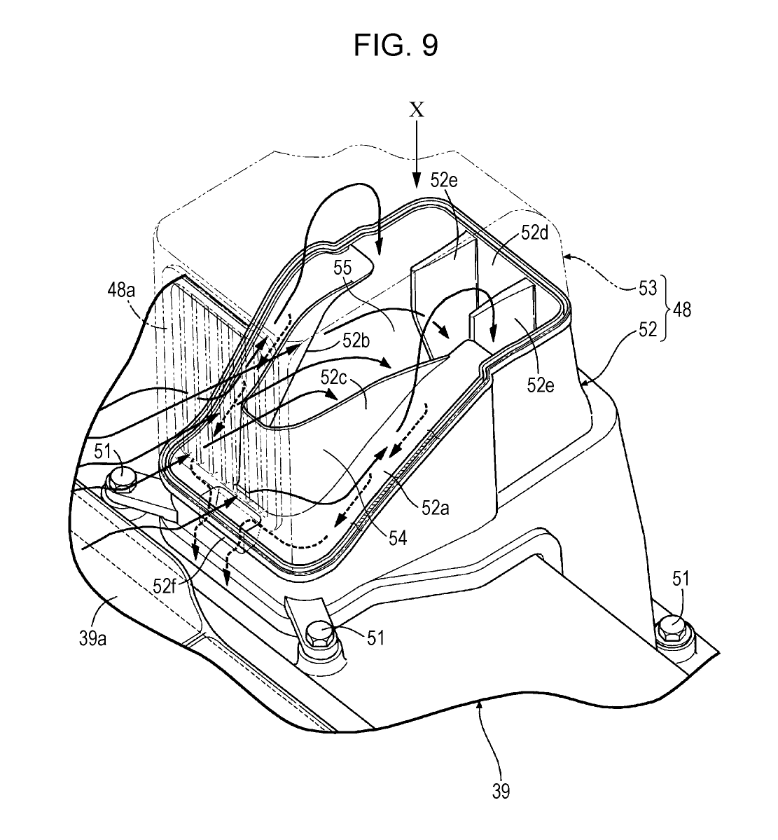

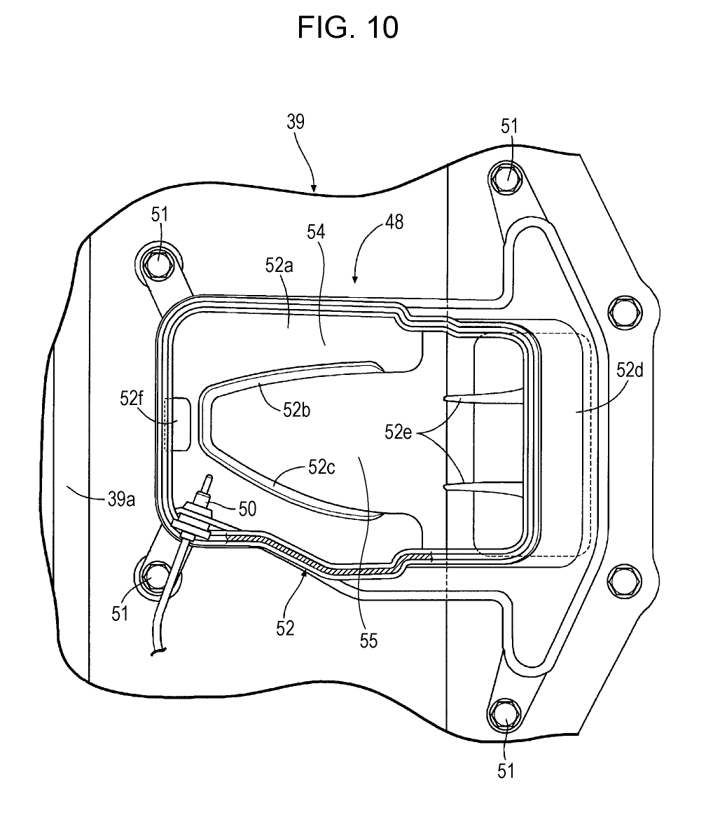

Embodiments of the present disclosure are described below with reference to FIGS. 1A and 1B and FIGS. 2 to 11.

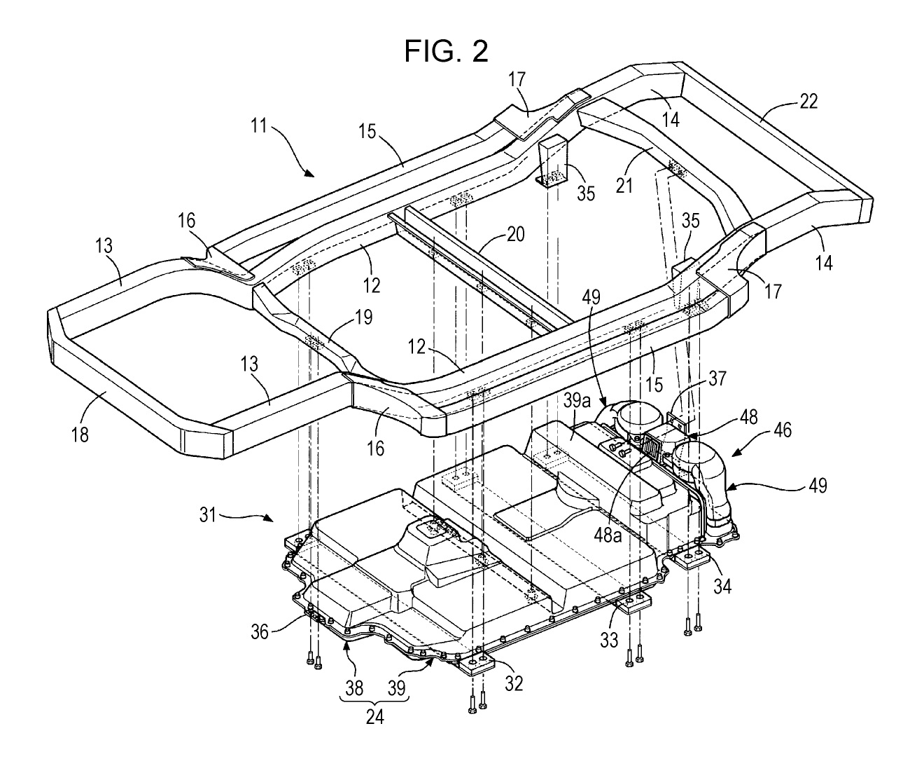

As illustrated in FIGS. 1A and 1B and FIG. 2, a undercarriage 11 of an electric vehicle includes a pair consisting of right and left floor flames 12 and 12 extending in the front—rear direction of the vehicle, a pair consisting of right and left front side frames 13 and 13 extending forward from the front ends of the floor frames 12 and 12 while curving upward, a pair consisting of right and left rear side frames 14 and 14 extending backward from the rear ends of the floor frames 12 and 12 while curving upward, a pair consisting of right and left side sills 15 and 15 disposed on the outside of the floor frames 12 and 12 in the width direction of the vehicle, a pair consisting of front outriggers 16 and 16 that connect the front ends of the side sills 15 and 15 to the front ends of the floor frames 12 and 12, a pair consisting of rear outriggers 17 and 17 that connect the rear ends of the side sills 15 and 15 to the rear ends of the floor frames 12 and 12, a front bumper beam 18 that extends in the width direction of the vehicle and connects the front end portions of the right and left front side frames 13 and 13 to each other, a front cross member 19 that extends in the width direction of the vehicle and connects the front end portions of the right and left floor frames 12 and 12 to each other, a middle cross member 20 that extends in the width direction of the vehicle and connects the middle portions of the right and left floor frames 12 and 12 in the front-rear direction to each other, a rear cross member 21 that extends in the width direction of the vehicle and connects the middle portions of the right and left rear side frames 14 and 14 in the front-rear direction to each other, and a rear bumper beam 22 that extends in the width direction of the vehicle and connects the rear end portions of the right and left rear side frames 14 and 14 to each other.

A battery pack 31 that serves as a power supply for a motor/generator 23 functioning as a travel drive source is suspended and supported by the undercarriage 11 on the lower side. That is, the lower surface of the battery pack 31 has a front hanger beam 32, a middle hanger beam 33, and a rear hanger beam 34 fixed thereon, which extend in the width direction of the vehicle. One end of the front hanger beam 32 is fixed to a front portion of the right floor frame 12, and the other end is fixed to a front portion of the left floor frame 12. One end of the middle hanger beam 33 is fixed to a rear portion of the right floor frame 12, and the other end is fixed to the left floor frame 12. One end of the rear hanger beam 34 is fixed to the lower end of one of two supporting members 35 and 35 that hangs from the front portion of the right rear side frame 14, and the other end is fixed to the lower end of the other supporting member 35 that hangs from the front portion of the left rear side frame 14. In addition, the middle portion of the front edge of the battery pack 31 in the width direction of the vehicle is supported by the front cross member 19 via a front bracket 36. Furthermore, the middle portion of the rear edge of the battery pack 31 in the width direction of the vehicle is supported by the rear cross member 21 via a rear bracket 37. Still furthermore, the battery pack 31 is supported by the lower surface of the middle cross member 20 at the midpoint between the front hanger beam 32 and the middle hanger beam 33.

When the battery pack 31 is supported by the undercarriage 11, the upper surface of the battery pack 31 faces the lower portion of a passenger compartment 25 with a floor panel 26 therebetween. That is, according to the present exemplary embodiment, the battery pack 31 is disposed outside the passenger compartment 25.

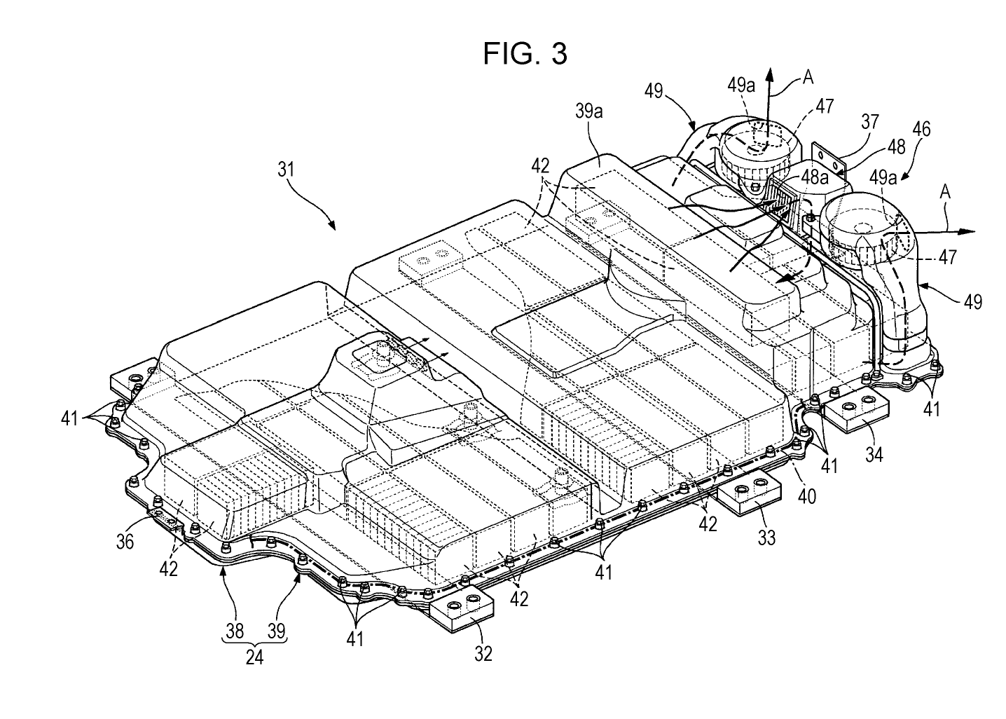

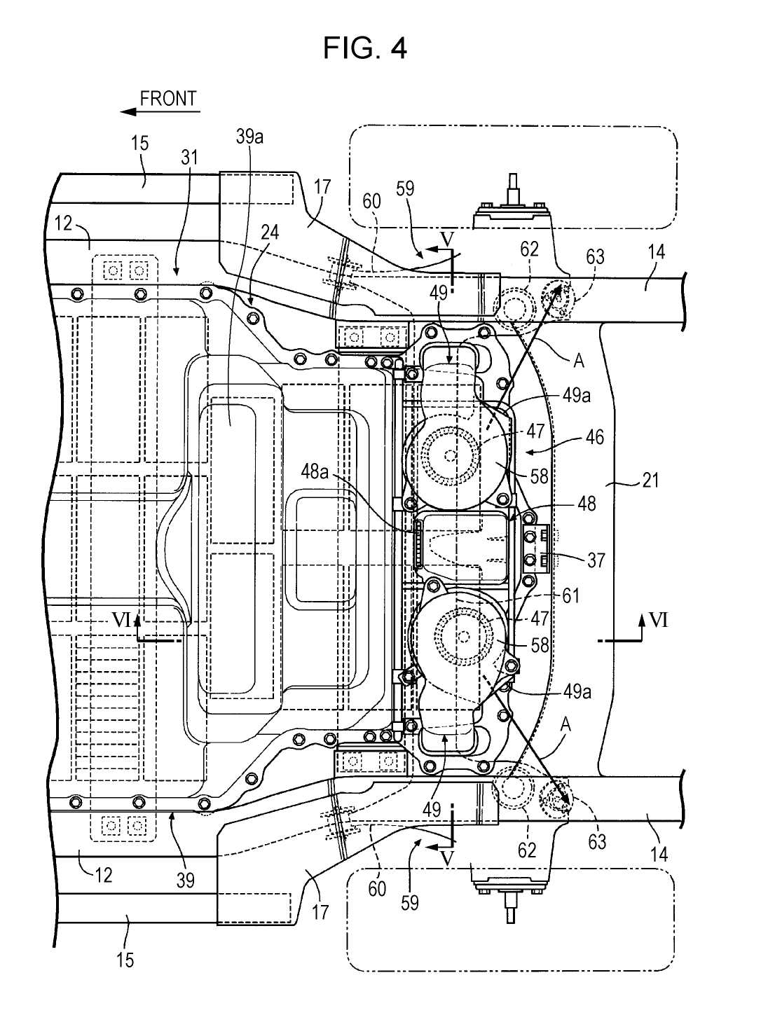

As illustrated in FIGS. 3 and 4, the battery pack 31 includes a metal battery tray 38 and a plastic battery cover 39 that covers the battery tray 38 from above. The outer edge portion of the battery tray 38 is joined to the outer edge portion of the battery cover 39 with a seal member 40 (refer to FIG. 3) therebetween using a plurality of bolts 41, 41, . . . Accordingly, the interior of the battery pack 31 basically creates a closed space. The upper surface of the battery tray 38 has a plurality of battery modules 42, 42, . . . (batteries) placed thereon. Each of the battery modules 42, 42, . . . includes a plurality of battery cells stacked in series. The battery tray 38 and the battery cover 39 form a battery case 24 according to the present exemplary embodiment.

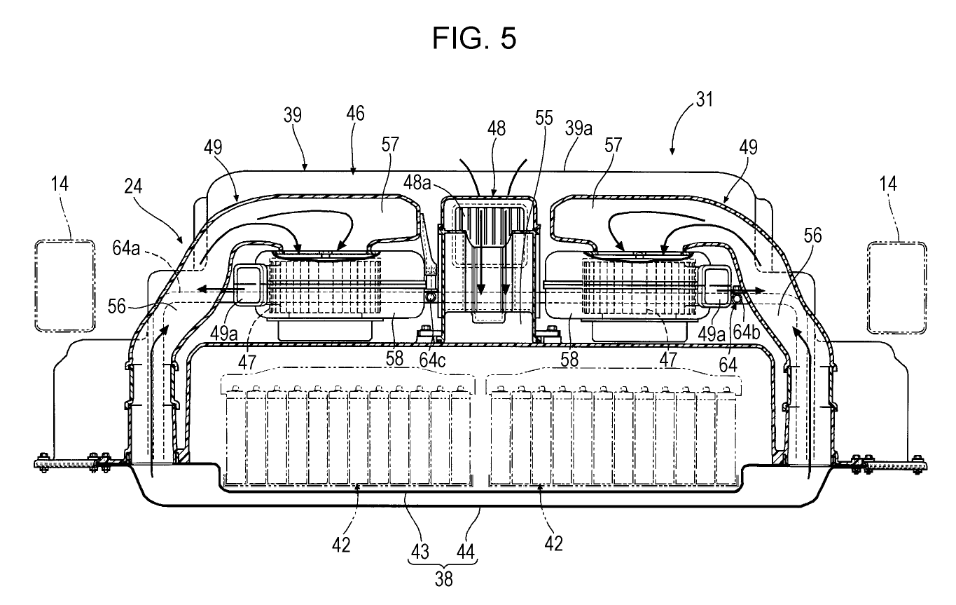

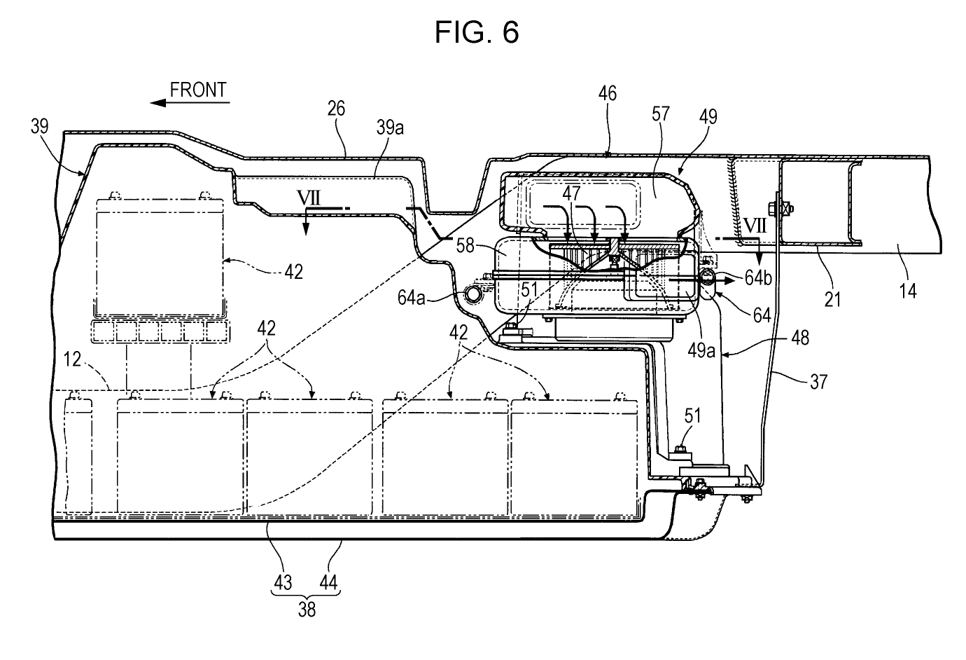

The battery tray 38 includes an upper plate 43 and a lower plate 44 joined together (refer to FIGS. 5 and 6). A cooling passage that allows cooling air flows therethrough is formed between the upper plate 43 and the lower plate 44. The battery tray 38 exchanges, with the cooling air, heat generated by the battery modules 42, 42, . . . that are in contact with the upper surface of the upper plate 43 and, thus, cools the battery modules 42, 42, . . . The heat is generated when the battery modules 42 is charged or discharged. The cooling passage of the battery tray 38 branches into two at a predetermined position, and two branched cooling passages are connected to two exhaust ducts 49 and 49 (refer to FIG. 3).

The rear portion of the battery pack 31 has a cooling apparatus 46 disposed in the rear portion thereof. The cooling apparatus 46 includes an air intake duct 48 (a cooling air intake member) disposed in the middle of the cooling apparatus 46 in the width direction of the vehicle and the right and left exhaust ducts 49 and 49 (first and second cooling air exhaust members) disposed on both sides of the air intake duct 48 in the width direction of the vehicle. The lower end of the air intake duct 48 is connected to the rear end of the battery tray 38. The lower ends of the right and left exhaust ducts 49 and 49 are connected to the rear end of the battery tray 38. The front surface of an upper portion of the air intake duct 48 has an opening of a cooling air intake port 48a formed therein. The cooling air intake port 48a draws air outside the battery pack 31 as cooling air. The cooling air intake duct 48a faces forward. In addition, each of the exhaust ducts 49 and 49 has an electric-powered cooling fan 47 disposed therein. Each of the exhaust ducts 49 and 49 has a cooling air exhaust port 49a for exhausting the cooling air subjected to heat exchange. Each of the cooling air exhaust ports 49a and 49a is formed so as to surround the outer periphery of the cooling fan 47. The right and left cooling air exhaust ports 49a and 49a have openings facing backward and outwardly in the width direction of the vehicle (refer to arrows A in FIGS. 3, 4, and 7).

Accordingly, if the cooling fans 47 and 47 are driven, cooling air drawn through the cooling air intake port 48a of the air intake duct 48 is supplied into the inside of the battery tray 38. The cooling air is heat-exchanged against the battery modules 42, 42, . . . while flowing inside the battery tray 38. Thereafter, the cooling air passes through the cooling fans 47 and 47 of the exhaust ducts 49 and 49 and is exhausted from the cooling air exhaust ports 49a and 49a.

The structure of the cooling apparatus 46 is described in detail next with reference to FIGS. 4 to 10.

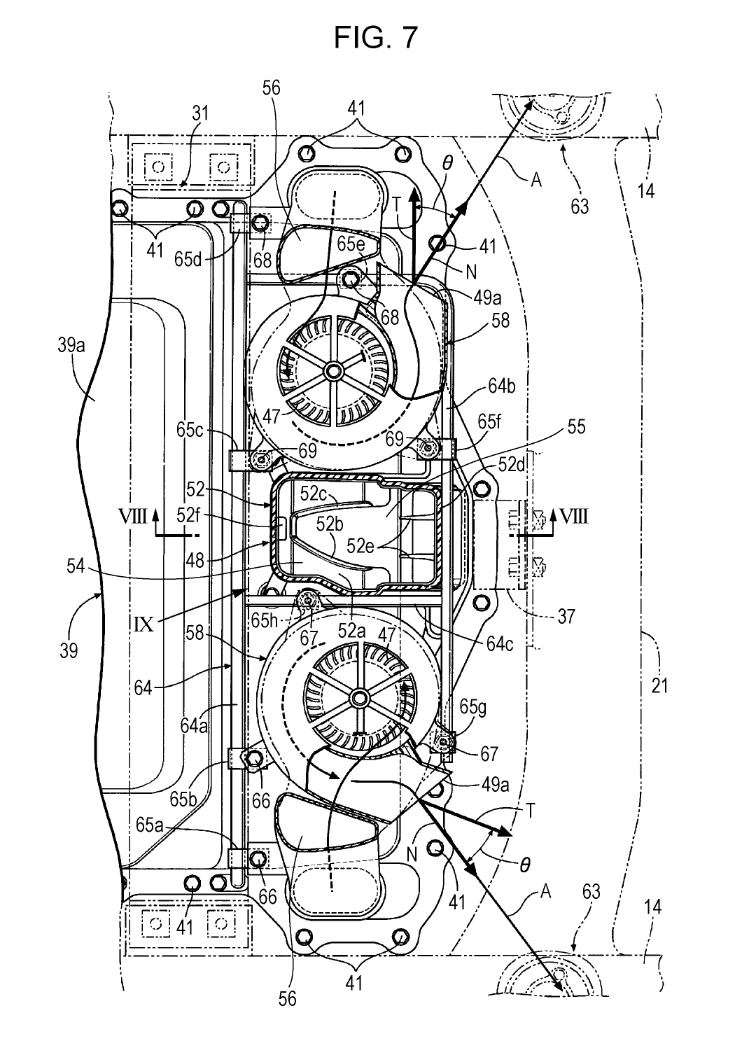

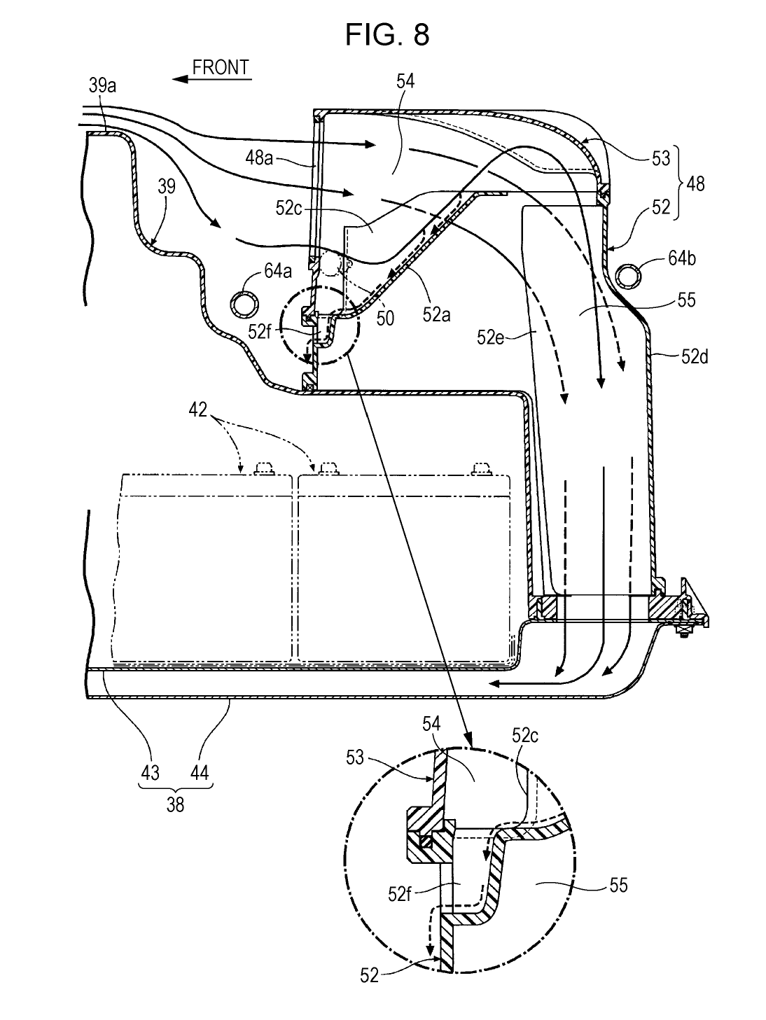

As illustrated in FIGS. 7 to 10, the battery cover 39 has a convex portion 39a protruding upward from a rear portion of the battery cover 39 (refer to FIG. 8). The air intake duct 48 of the cooling apparatus 46 is disposed behind the convex portion 39a. The cooling air intake port 48a includes a lower member 52 fixed to the upper surface of the battery cover 39 using four bolts 51, 51, . . . and a upper member 53 joined to the lower member 52 so as to cover an upper end opening of the lower member 52. The cooling air intake port 48a is formed on the front surface of the upper member 53. The cooling air intake port 48a is located above the rear portion of the battery pack 31 and behind the convex portion 39a of the battery cover 39.

The air intake duct 48 includes an upstream intake passage 54 that extends backward from the cooling air intake port 48a and a downstream intake passage 55 that extends downward from the upstream intake passage 54 and communicates with the battery tray 38. The upstream intake passage 54 is formed so as to be partitioned in the upper member 53. The downstream intake passage 55 is formed so as to be partitioned in the lower member 52.

The upper surface of the lower member 52 has a bottom wall 52a integrated thereinto. The bottom wall 52a separates the upstream intake passage 54 from the downstream intake passage 55. The bottom wall 52a is inclined so that the height gradually increases from the front to the back. The middle portion of the bottom wall 52a in the width direction of the vehicle has a notch 52b formed therein. The notch 52b extends in a U shape or V shape from the front to the back. A vertical wall 52c extends upward from the edge of the notch 52b. A space that allows cooling air to flow therein is formed between the upper end of the vertical wall 52c and the ceiling portion of the upper member 53. A side wall 52d located behind the lower member 52 that faces the cooling air intake port 48a has two ribs 52e and 52e that extend inside the downstream intake passage 55 in the vertical direction. The ribs 52e and 52e protrude forward. The lower ends of the ribs 52e and 52e extend to a connection portion connected to the battery tray 38. The lower end of the bottom wall 52a located under the cooling air intake port 48a has a drainage hole 52f formed therein. The drainage hole 52f allows the upstream intake passage 54 to communicate with the outside of the air intake duct 48.

In addition, the upstream intake passage 54 of the air intake duct 48 includes a temperature sensor 50 for detecting the temperature of drawn cooling air. The temperature sensor 50 is disposed at a position lower than the upper end of the vertical wall 52c.

As illustrated in FIGS. 4 to 7, each of the exhaust ducts 49 and 49 of the cooling apparatus 46 includes an upstream exhaust passage 56 (first and second cooling air exhaust passages) that extends upward from the rear end of the battery tray 38 and a downstream exhaust passage 57 (first and second cooling air exhaust passages) that extends from the upper end of the upstream exhaust passage 56 to the inner side in the width direction of the vehicle. The cooling fans 47 and 47 are disposed immediately beneath the downstream exhaust passages 57 and 57. The outer peripheries of the cooling fans 47 and 47 are surrounded by spiral fan casings 58 and 58. The cooling air exhaust ports 49a and 49a are formed at outer ends of the spiral fan casings 58 and 58.

The spiral fan casings 58 and 58 of the right and left cooling fans 47 and 47 are formed from members that are similar and are exchangeable. Accordingly, in plan view (refer to FIG. 7), the right and left fan casings 58 and 58 are asymmetrical about the center of the vehicle body. As described above, the cooling air exhaust ports 49a and 49a of the right and left cooling fans 47 and 47 exhaust the cooling air in the backward direction and outwardly in the width direction of the vehicle, as indicated by the arrows A. Therefore, each of normal lines N and N that are normal to the cooling air exhaust ports 49a and 49a is inclined from a tangent line T of the fan casing 58 by an angle θ.

The cooling air flows out in a direction perpendicular to a plane formed by each of the cooling air exhaust ports 49a and 49a. Accordingly, by inclining the normal line N that is perpendicular to each of the cooling air exhaust ports 49a and 49a from the tangent line T of the fan casings 58 by an angle θ, the cooling air can be exhausted from the cooling air exhaust ports 49a and 49a in directions that are substantially bilaterally symmetrical while using exchangeable similar members as the right and left fan casings 58 and 58.

Suspension systems 59 and 59 (refer to FIG. 4) that suspend the rear wheels are formed from, for example, an “H” torsion beam suspension. The “H” torsion beam suspension includes right and left trailing arm units 60 and 60, a torsion beam unit 61 that extends in the width direction of the vehicle and connects the right trailing arm unit 60 to the left trailing arm unit 60, and right and left suspension springs 62 and 62 and right and left suspension dampers 63 and 63 that support the rear ends of the trailing arm units 60 and 60 on the lower surface of the rear side frames 14 and 14.

In plan view, the direction in which the cooling air is exhausted from each of the cooling air exhaust ports 49a and 49a of the right and left fan casings 58 and 58 (refer to the arrow A) partially overlaps one of the suspension systems 59 and 59 (the suspension dampers 63 and 63 in the present exemplary embodiment). By setting the direction A in which the cooling air is exhausted from each of the cooling air exhaust ports 49a and 49a to the above-described direction, interference between the cooling air and the vehicle body can be minimized and, thus, the cooling air can be smoothly exhausted through the spaces of the suspension systems 59 and 59.

The exhaust ducts 49 and 49 are supported on the upper surface of a rear portion of the battery case 24 by a support frame 64 together with the cooling fans 47 and 47. The support frame 64 includes a first frame 64a, a second frame 64b, and a third frame 64c. The first frame 64a is made from a pipe member bent into an inverted U-shape. Both end portions of the first frame 64a extend upward from the right and left portions of the upper surface of the battery cover 39. The second frame 64b is connected to the right end of the first frame 64a and extends backward and leftward. The third frame 64c has an I-shape that connects the left end portion of the second frame 64b to the middle portion of the first frame 64a.

The support frame 64 further includes four attaching brackets 65a to 65d fixed to the first frame 64a, three attaching brackets 65e to 65g fixed to the second frame 64b, and an attaching bracket 65h fixed to the third frame 64c (refer to FIG. 7). The left exhaust duct 49 is fastened to the two attaching brackets 65a and 65b of the first frame 64a using bolts 66 and 66. The left exhaust duct 49 and the left cooling fan 47 are fastened together to the attaching bracket 65g of the second frame 64b and the attaching bracket 65h of the third frame 64c using bolts 67 and 67 (first and second fixing members).

In addition, the right exhaust duct 49 is fastened to the attaching bracket 65d of the first frame 64a and the attaching bracket 65e of the second frame 64b using bolts 68 and 68. The right exhaust duct 49 and the right cooling fan 47 are fastened together to the attaching bracket 65c of the first frame 64a and the attaching bracket 65f of the second frame 64b using bolts 69 and 69 (first and second fixing members).

Since the exhaust ducts 49 and 49 and the cooling fans 47 and 47 are fastened together to the support frame using the shared bolts 67, 67, 69, and 69 in this manner, the size of the cooling apparatus 46 can be reduced. In addition, the number of parts can be reduced.

An exemplary operation performed in the above-described structure of the present embodiment is described next.

Since the battery modules 42, 42, . . . contained in the battery case 24 of the battery pack 31 generate heat during charge and discharge, the battery modules 42, 42, . . . are cooled using cooling air supplied to the inside of the battery tray 38 by the cooling apparatus 46. That is, when the cooling fans 47 and 47 are driven, air located above the upper surface of the battery case 24 and air located below the lower surface of the floor panel 26 are drawn from the cooling air intake port 48a of the air intake duct 48 as cooling air. The cooling air flows through the upstream intake passage 54 and the downstream intake passage 55 of the air intake duct 48. Thereafter, the cooling air is supplied to the inside of the battery tray 38.

As illustrated in FIG. 3, the cooling air supplied to the inside of the battery tray 38 branches at a predetermined position and flows through the pair of exhaust ducts 49 and 49. At that time, the heat is exchanged between the upper plate 43 of the battery tray 38 and the lower surfaces of the battery modules 42, 42, . . . Thus, the battery modules 42, 42, . . . are cooled. The cooling air flowing into the exhaust ducts 49 and 49 passes through the upstream exhaust passages 56 and 56, the downstream exhaust passages 57 and 57, and the cooling fans 47 and 47. Thereafter, the cooling air is exhausted from the cooling air exhaust ports 49a and 49a of the fan casings 58 and 58.

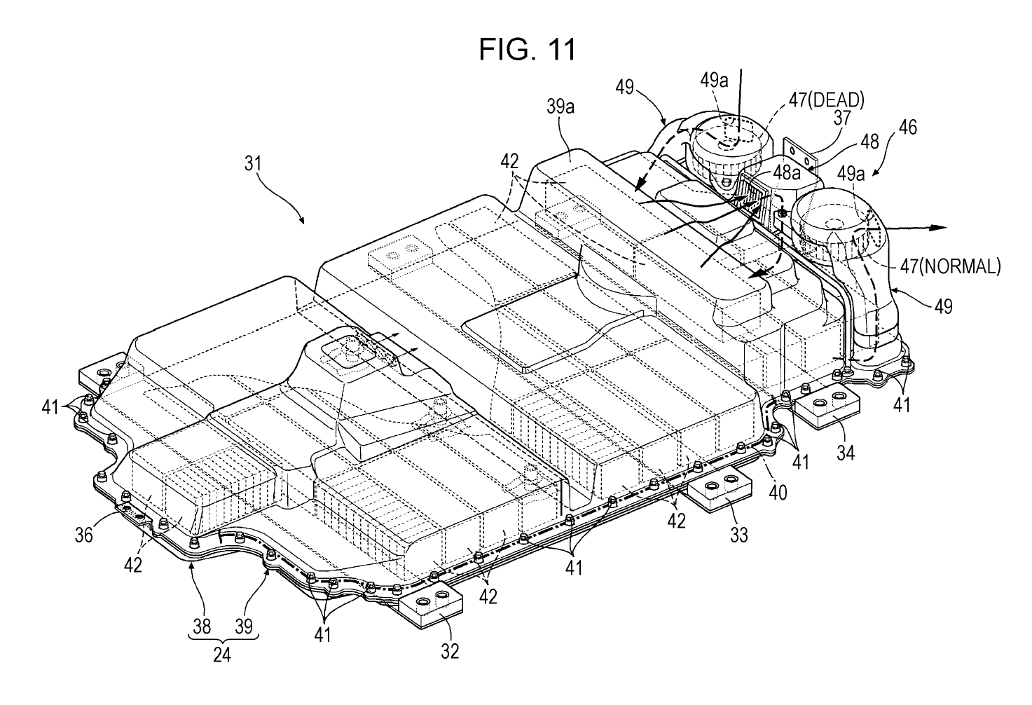

At that time, as illustrated in FIG. 11, even when one of the right and left cooling fans 47 and 47 malfunctions and does not operate, the operation performed by the other cooling fan 47 allows the cooling air to flow from the air intake duct 48 to the other cooling fan 47 via the cooling passage and the other exhaust duct 49. In addition, the operation performed by the other cooling fan 47 allows the cooling air to flow from one of the exhaust ducts 49 to the other cooling fan 47 via the cooling passage and the other exhaust duct 49. In this manner, all of the battery modules 42, 42, . . . in the battery case 24 can be cooled.

Furthermore, the battery pack 31 is disposed under the passenger compartment 25, and the air intake duct 48 and the exhaust ducts 49 and 49 are disposed so as to be sandwiched by the battery case 24 and the passenger compartment 25. Accordingly, unlike a structure in which a different member, such as a pipe duct, is connected and cooling air is drawn from the front side of the battery case 24 and is exhausted from the rear side of the battery case 24 and vice versa, the intake path and the exhaust path of cooling air can be set on the upper surface of the battery case 24. As a result, interference between parts disposed in front of and behind the battery case 24 and the battery case 24 negligibly occurs. Therefore, the design of the layout of the battery case 24 is facilitated. In addition, since the need for connecting, for example, a pipe duct to the battery case 24 is eliminated, the need for a sealing member in the connection portion is eliminated. Thus, the number of parts can be reduced.

Still furthermore, the air intake duct 48 and the exhaust ducts 49 and 49 are disposed so as to at least partially overlap each other as viewed in the width direction of the vehicle. Accordingly, the air intake duct 48 and the exhaust ducts 49 and 49 can be packed into a compact unit. In addition, the air intake duct 48 and the exhaust ducts 49 and 49 negligibly interfere with the floor panel 26 having a stepped portion extending in the width direction of the vehicle and the rear cross member 21 extending in the width direction of the vehicle. Thus, the design of the layout of the battery pack 31 in the vehicle body can be facilitated. Yet still furthermore, the exhaust ducts 49 and 49 are disposed in both end portions of the air intake duct 48 disposed in the middle of the width of the vehicle. Accordingly, by disposing the exhaust ducts 49 and 49 between the air intake duct 48 and the wheels that splash dirt and water, the probability of dirt and water drawn through the cooling air intake port 48a together with cooling air can be reduced.

Yet still furthermore, the air intake duct 48 is disposed above the rear end portion of the battery cover 39. In addition, the convex portion 39a is provided on the battery cover 39 so as to protrude upward toward the passenger compartment 25, and the air intake duct 48 is disposed behind the convex portion 39a of the battery cover 39. Accordingly, dirt and water splashed from the front of the moving vehicle can be blocked by the convex portion 39a of the battery cover 39. Thus, the probability of dirt and water drawn through the cooling air intake port 48a entering the inside of the battery cover 39 together with cooling air can be reduced.

Yet still furthermore, the cooling air intake port 48a of the air intake duct 48 opens to the front of the vehicle, while the cooling air exhaust ports 49a and 49a of the exhaust ducts 49 and 49 open to the rear of the vehicle. Accordingly, the cooling air exhausted from the cooling air exhaust ports 49a and 49a and having a raised temperature after heat exchange is negligibly drawn into the battery tray 38 through the cooling air intake port 48a again. Thus, a decrease in the cooling efficiency of the battery modules 42, 42, . . . due to recirculation of the cooling air can be prevented. In particular, since the cooling air exhaust ports 49a and 49a open to the rear of the vehicle and to the outer sides in the width direction of the vehicle, the cooling air exhausted from the cooling air exhaust ports 49a and 49a can be urged backward by air currents flowing along the right and left side surface of the vehicle body when the vehicle is moving. Thus, the exhausted cooling air negligibly stays in the vicinity of the battery pack 31.

Yet still furthermore, the air intake duct 48 can effectively separate water contained in the cooling air due to a special form thereof. Thus, the air intake duct 48 can prevent water from entering the battery tray 38. That is, the cooling air drawn from the lower portion of the cooling air intake port 48a of the air intake duct 48 to the upstream intake passage 54 branches to the right and left by the vertical wall 52c that flares towards downstream while flowing upward along the upward-tilted bottom wall 52a. The cooling air is brought into contact with the bottom wall 52a and the vertical wall 52c so that water is separated. Thereafter, the cooling air current is deflected downward from the downstream end of the bottom wall 52a and flows into the downstream intake passage 55. The water separated from the cooling air goes down along the vertical wall 52c and the bottom wall 52a by the force of gravity and is drained from the drainage hole 52f disposed in the lower portion of the bottom wall 52a to the outside of the air intake duct 48.

The cooling air drawn from the upper portion of the cooling air intake port 48a of the air intake duct 48 to the upstream intake passage 54 flows through the upper end of the vertical wall 52c and, subsequently, is deflected downward. The cooling air flows through the notch 52b formed in the bottom wall 52a and enters the downstream intake passage 55. In this way, the cooling air that enters the downstream intake passage 55 flows downward while being rectified by the ribs 52e and 52e formed on the side wall 52d. Thereafter, the cooling air enters the cooling passage of the battery tray 38.

In this manner, by efficiently retrieving water contained in the cooling air by the bottom wall 52a and the vertical wall 52c disposed in the air intake duct 48, intrusion of water into the battery tray 38 can be prevented. In addition, by increasing the cross sectional area of the flow passage by providing the notch 52b to the bottom wall 52a, an increase in a pressure drop due to the presence of the bottom wall 52a and the vertical wall 52c can be minimized. Thus, water separation and a decrease in pressure drop can be effectively provided at the same time.

Note that the temperature sensor 50 disposed in the air intake duct 48 detects the temperature of the cooling air (the intake air temperature). If a battery temperature detected by a temperature sensor (not illustrated) is higher or equal to the intake air temperature, the cooling fans 47 and 47 are started. However, if the battery temperature is lower than the intake air temperature, the cooling fans 47 and 47 are stopped. If the cooling fans 47 and 47 are stopped, the cooling air having a high temperature and a low specific gravity in the battery tray 38 may flow back upward in the air intake duct 48. Accordingly, the cooling air may stay in the vicinity of the ceiling of the upper member 53 of the air intake duct 48.

At that time, if the temperature sensor 50 is disposed in the vicinity of the ceiling of the upper member 53 of the air intake duct 48, the temperature sensor 50 does not detect an accurate intake air temperature. The temperature sensor 50 detects the temperature of the high-temperature air staying in the vicinity of the ceiling. Accordingly, even when the battery temperature rises, it is likely that the cooling fans 47 and 47 are not promptly driven. However, according to the present exemplary embodiment, since the temperature sensor 50 is disposed at a position lower than the upper end of the vertical wall 52c of the air intake duct 48, erroneous detection of the intake air temperature can be prevented.

While the present disclosure has been described with reference to an exemplary embodiment, various design changes can be made without departing from the principle and scope of the disclosure.

For example, while the exemplary embodiment has been described with reference to one air intake duct 48 and two exhaust ducts 49 and 49, each of the number of the air intake ducts 48 and the number of the exhaust ducts 49 may be any desired number.

In addition, it is only required that at least part of the upstream exhaust passage 56 and at least part of the downstream exhaust passage 57 are located between the cooling fan 47 and the passenger compartment 25.

According to an embodiment, an electric vehicle battery pack includes a battery case disposed under the passenger compartment, where the battery case includes a plurality of batteries, a cooling air intake member configured to draw cooling air into a cooling passage formed in the battery case, and at least one cooling air exhaust member configured to exhaust the cooling air from the cooling passage. The cooling air exhaust member includes a cooling air exhaust passage that allows the cooling air passed through the cooling passage to flow therethrough, a cooling fan that exhausts the cooling air passed through the cooling air exhaust passage to the outside, and a support frame that supports the cooling air exhaust passage and the cooling fan on the battery case. The cooling air intake member and the cooling air exhaust member are disposed between the battery case and the passenger compartment, and at least part of the cooling air exhaust passage is disposed between the cooling fan and the passenger compartment. In such a configuration of the embodiment, the cooling air intake member that draws cooling air into a cooling passage formed in the battery case including a plurality of batteries and disposed under a passenger compartment and the cooling air exhaust member that exhausts the cooling air from the cooling passage are disposed between the battery case and the passenger compartment. Accordingly, by disposing the cooling air intake member and the cooling air exhaust member at a higher position in the battery pack and disposing the battery case between the road surface and each of the cooling air intake member and the cooling air exhaust member, dirt and water splashed from the road surface and the wheel negligibly enter the battery case through the cooling air intake member and the cooling air exhaust member. In addition, since at least part of the cooling air exhaust passage of the cooling air exhaust member is disposed between the cooling fan and the passenger compartment, noise and vibration generated by the cooling fan can be blocked by the cooling air exhaust passage. Thus, noise and vibration generated by the cooling fan can be negligibly transferred to the passenger compartment. Furthermore, even when water enters the battery case through the cooling fan that is stopped, intrusion of the water into the cooling passage can be more effectively prevented, since the cooling air exhaust passage is located above the cooling fan.

The cooling air exhaust passage and the cooling fan can be together fastened to the support frame with a common fixing member. In such a structure of the embodiment, the number of parts of the fixing member and the number of steps of assembling parts can be reduced.

The cooling passage of the embodiment can include an upstream cooling passage that communicates with the cooling air intake member and two downstream cooling passages that branch from the upstream cooling passage and that communicate with two cooling air exhaust members, and the cooling fan can be disposed in each of the two cooling air exhaust members. Accordingly, if the two cooling fans operate normally, cooling air drawn from the cooling air intake member to the upstream cooling passage branches to the two downstream cooling passages and is exhausted from the two cooling air exhaust members. However, if one of the two cooling fans malfunctions and the other cooling fan normally operates, the cooling air can flow from the cooling air intake member to one of the cooling air exhaust members via the upstream cooling passage and one of the downstream cooling passages. In addition, the cooling air can flow from the other cooling air exhaust member to the one of the cooling air exhaust members via the other downstream cooling passage and the one of the downstream cooling passages. In this manner, all of the batteries in the battery case can be cooled.

The cooling air intake member can be disposed in the middle of the width of the vehicle, and the cooling air exhaust member can be disposed on both sides of the cooling air intake member in the width direction of the vehicle. In such a structure of the embodiment, since the cooling air exhaust member is located between the wheel that splashes dirt and water and the cooling air intake member, the dirt and water can be negligibly drawn into the cooling air intake member together with the cooling air.

Obviously, numerous modifications and variations of the present invention are possible in light of the above teachings. It is therefore to be understood that within the scope of the appended claims, the invention may be practiced otherwise than as specifically described herein.

What is claimed is:

1. An electric vehicle battery pack comprising:
a battery case disposed under a passenger compartment of an electric vehicle to contain a plurality of batteries, the battery case including a cooling passage through which cooling air is to pass;
a cooling air intake member through which the cooling air is to be drawn into the cooling passage and which is disposed between the battery case and the passenger compartment;
a first cooling air exhaust member through which the cooling air is to be exhausted from the cooling passage and which includes a first cooling air exhaust passage through which the cooling air from the cooling passage is to flow, the first cooling air exhaust member being disposed between the battery case and the passenger compartment;
a first cooling fan to exhaust the cooling air from the first cooling air exhaust passage to outside of the first cooling air exhaust member, at least a part of the first cooling air exhaust passage being disposed between the first cooling fan and the passenger compartment; and
a support frame provided on the battery case to support the first cooling air exhaust member and the first cooling fan.

2. The electric vehicle battery pack according to claim 1, wherein the first cooling air exhaust member and the first cooling fan are together fastened to the support frame with a first fixing member.

3. The electric vehicle battery pack according to claim 1, further comprising:
a second cooling air exhaust member through which the cooling air is to be exhausted from the cooling passage and which includes a second cooling air exhaust passage through which the cooling air from the cooling passage is to flow, the second cooling air exhaust member being disposed between the battery case and the passenger compartment; and
a second cooling fan to exhaust the cooling air from the second cooling air exhaust passage to outside of the second cooling air exhaust member, at least a part of the second cooling air exhaust passage being disposed between the second cooling fan and the passenger compartment.

4. The electric vehicle battery pack according to claim 3,
wherein the cooling passage includes
an upstream cooling passage communicating with2 the cooling air intake member,
a first downstream cooling passage connecting the upstream cooling passage to the first cooling air exhaust member, and
a second downstream cooling passage connecting the upstream cooling passage to the second cooling air exhaust member, and
wherein the first and second cooling fans are disposed in the first and second cooling air exhaust members.

5. The electric vehicle battery pack according to claim 4,
wherein the cooling air intake member is disposed in a middle of a width of the electric vehicle, and
wherein the first and second cooling air exhaust members are disposed on respective sides of the cooling air intake member in a width direction of the electric vehicle.

6. The electric vehicle battery pack according to claim 3, wherein the second cooling air exhaust member and the second cooling fan are together fastened to the support frame with a second fixing member.

7. The electric vehicle battery pack according to claim 3, wherein at least a part of the second cooling air exhaust passage is provided above the second cooling fan.

8. The electric vehicle battery pack according to claim 7,
wherein the second cooling air exhaust member includes a second cooling air exhaust port communicating with the second cooling air exhaust passage, and
wherein at least a part of the second cooling air exhaust passage is provided above the second cooling air exhaust port.

9. The electric vehicle battery pack according to claim 1, wherein at least a part of the first cooling air exhaust passage is provided above the first cooling fan.

10. The electric vehicle battery pack according to claim 9,
wherein the first cooling air exhaust member includes a first cooling air exhaust port communicating with the first cooling air exhaust passage, and
wherein at least a part of the first cooling air exhaust passage is provided above the first cooling air exhaust port.
